(19) United States
(12) Patent Application Publication
(10) Pub. No.: US 2004/0108432 A1
(43) Pub. Date: Jun. 10, 2004

(54) Purse holder

(76) Inventor: Candee Weitzman, Palm Beach, FL (US)

Correspondence Address: AKERMAN SENTERFITT, P.O. BOX 3188, WEST PALM BEACH, FL, 33402-3188, US

(21) Appl. No.: 10/702,172

(22) Filed: Nov. 4, 2003

Related U.S. Application Data
(60) Provisional application No. 60/429,747, filed on Nov. 27, 2002.

(51) Int. Cl. B42F 13/00

(52) U.S. Cl. 248/339; 248/914

(57) ABSTRACT

A hook-like holder to enable purses to be hung from tables or other flat surfaces to avoid their placement on floors, tables, or uncomfortably in laps. The holder has an adjustability feature to enable its use on different types of structures. The top portion is ornamental in nature, to provide a pleasing and in fact conversational effect.

### CROSS-REFERENCE TO RELATED APPLICATIONS

Under 35 U.S.C. §119(e) this application claims the benefit of U.S. Provisional Application No. 60/429,747 entitled Purse Holder, filed on Nov. 27, 2002, the entirety of which is now incorporated herein by reference.

### BACKGROUND OF THE INVENTION

People of all ages, particularly women, routinely carry handbags or purses, which while convenient for carrying numerous items, can also become an inconvenience in themselves where the handbag owner reaches a destination such as a dinner engagement Typically, at such engagement, a handbag owner has a choice of setting the handbag on the table, where it may be in the way, or on the floor, which might be dirty or an otherwise unacceptable alternative. Security issues come into play when the handbag is out of the sight of its owner.

If the handbag owner is at a formal event, placing the handbag on the table may not be an option, either because of social taboos or simply because of a lack of meaningful space. One possible solution to this dilemma is to provide a device useful in hanging the handbag from a table top, while its owner is seated.

While in the past, there have been devices to hang purses or handbags from tables, such devices have lacked further utility, such as being adjustable to accommodate different types of surfaces.

### SUMMARY OF THE INVENTION

Accordingly, it is an object of the present invention to provide improved means to temporarily hang a handbag or purse from a structure such as a table and in particular, the table top.

It is a further object of the subject invention to provide such improved device which can be folded up for travel purposes when not in use.

It is still another object of the subject invention to provide a device, for hanging bags, which is adjustable and can therefore be used with different size and shape structures.

It is but another object of the subject invention to provide a device for hanging purposes which has a substantially ornamental appearance so as to be acceptable as a decorative piece.

It is one more object of the subject invention to provide a device to hang any carried items such as packages and bags, from a table top.

It is still one more object of the subject invention to provide an inexpensive but pleasing hanging device that in itself will be a non-obtrusive conversation piece.

In accordance with the above objects, the handbag hanging device features a hook-like member which engages the bag or purse and allows it to hang below a horizontal surface such as a table top or windowsill. The device extends upwardly from the hook member and bends into an upper extremity of approximately a ninety degree angle to become engageable with a top member that will rest on the table top when the device is in use. The top member has a hollow portion through which the hook-like member piece extends, the latter of which terminates in an expanded end portion larger than the hollow portion and acts as a locking means for the upper extremity of the hook-like member within the top member. The length of the upper extremity of the hook-like member allows for adjustability and placement of the device on surfaces having different characteristics, enabling the securement thereof on such surfaces. The upper extremity of the hook-like member as it extends through the hollow portion of the top member is rotatable within to permit the device to be folded when not in use.

The top member, in addition to stabilizing the hanging bag when held to a table top surface, can be ornamental to provide a pleasing effect for the device, and in fact causing it to become a conversational piece through a pleasing artistic presentation.

### BRIEF DESCRIPTION OF THE DRAWINGS

FIG. 1 is an elevational view of the device, showing an artistic rendition of a miniature purse for the top member.

FIG. 2 is a side elevational view of the device of FIG. 1.

FIG. 3 shows an alternative embodiment with an artistically different top member of the device and which is shown positioned on a horizontal table top with a handbag hung therefrom.

FIG. 3A shows a further alternative embodiment of the hook-like portion of FIG. 3 with the hook-like portion turned 90 degrees to cause the hanging handbag to assume a different orientation.

FIG. 3B shows a further alternative embodiment of the hook-like portion of FIG. 3 which includes a ring like member to cause the hanging handbag to assume a different orientation.

### DETAILED DESCRIPTION OF THE DRAWINGS

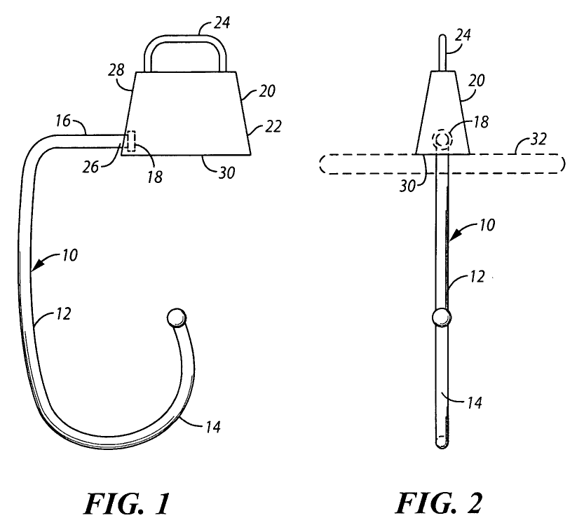

With reference to FIG. 1, the preferred embodiment of purse holder 10, in accordance with the subject invention is shown, essentially comprising two members. The first member 12 is made up of a thick wire-like member which has a hook-like portion 14 at one end and terminates in an approximately ninety degree bend near the other end. The ninety degree bend portion 16 terminates in an expanded end piece 18.

The second member 20 of the device 10 comprises a structure intended to be ornamental in nature, which will be suitable to be placed on the top of a flat surface (not shown), such as a table top. The second member 20, which as shown in FIG. 1, is shaped as a small purse replica. Member 20 is hollow and has an opening 26 through which upper extremity 16 of member 12 extends in such a way as to be adjustable, allowing extremity 16 to extend outwardly to its full extent from the side wall 28 of the top member.

As can be appreciated, in use, the device 10 is placed on a table top with bottom 30 resting on the top surface of a table. See FIG. 2 where a partial table top is shown in phantom 32.

When not in use extremity 16 can be slid within top member 20, to produce a foldable, compact device that can be carried in one's purse for future use.

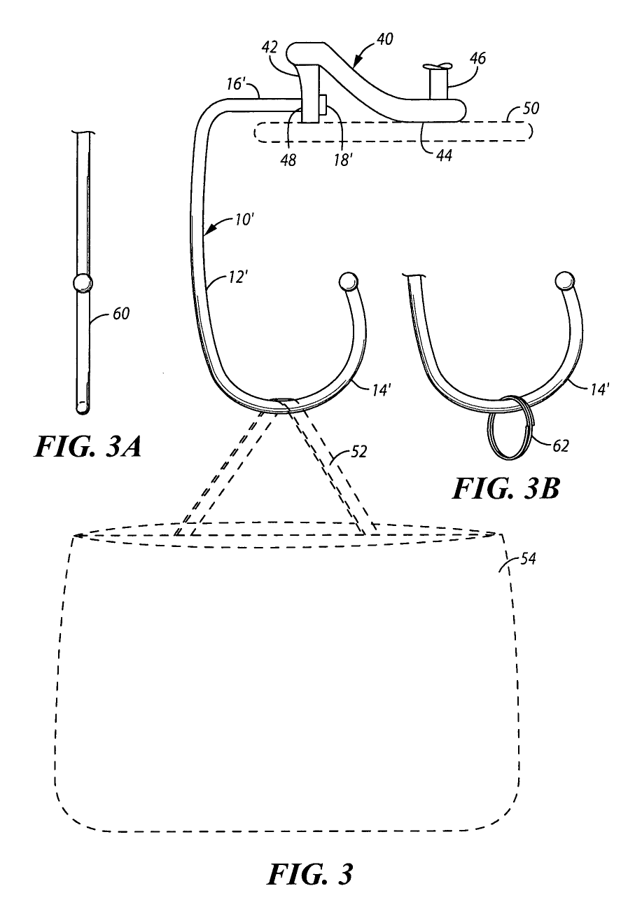

Any variety of artistic tops may be used. Examples are animal figurines, and inanimate objects such as a shoe (see FIG. 3).

With respect to FIG. 3, an alternative embodiment of a purse holder 10′ is shown. Instead of the use of a top member 40 which is hollow (FIG. 1), a shoe replica is shown having a heel 42, sole 44, and strap 46. The upper extremity 16′ of the wire-like member 12′ extends through an opening 48 in the heel 42 of the shoe. Upper extremity 16′ terminates in knob 18′ larger than opening 48 so that extremity 16′ will always be slideable within opening 48 and not completely removable from top member 40. In use, the shoe replica 40 will rest balanced on a table top 50. The hook-like portion 14′ of member 12′ will receive the strap 52 of purse 54 as it hangs below the table top 50.

When not in use and the purse 54 is removed from the purse holder 10′, upper extremity 16′ of lower member 12′ can be slid through opening 48 to make the device more compact for storage.

The slideability of upper extremity 16′ enables the holder 10′ to be equally adaptable for use with table tops, window sills, etc and various structures of different dimensions.

With reference to FIG. 3A, an alternative embodiment to the purse holders of FIGS. 1-3 is shown. As hook-like portion 60 appears, it is turned 90 degrees to the hook-like portions 14, 14¹ of the earlier embodiments so that its orientation becomes parallel to the edge of table top 50. When a purse strap 52 is hung on hook-like portion 60, it will assume a perpendicular orientation to the edge of table 50 in FIG. 3 and actually hang as bag 54 is shown in FIG. 3. If the orientation of hook-like portion 14¹ is used, the bag 54 will actually hang parallel to the edge of table top 50.

If the embodiment of FIG. 3A is used, hanging bags will be less likely to interfere with the owner or the person sitting next to her, as the hanging bag will be oriented to hang inwardly with respect to the table tops and not parallel to its edge.

A further embodiment for creating the handbag orientation of FIG. 3A is shown by FIG. 3B, as exemplified by ring 62, which may be essentially a key ring to which the handbag strap can be slipped onto before the ring 62 is slipped onto hook-like portion 14¹, which will have the orientation as shown in FIG. 3. When the strap engages the ring 62 instead of hook-like portion 14¹ directly, its hanging orientation changes from parallel to the edge of the table to perpendicular thereto, thus taking up less space around the table.

The purse holders 10, 10′ while preferably constructed of a metallic composition could as well be constructed of virtually any material including wood or plastic. Consistent with their artistic presentation, the purse holders will often be finished with a gold or silver finish.

Knob 18′ can be either a permanent end on extremity 16′ or attachable by means of compatible threads between Knob 18′ and extremity 16′. Not only does this attachable feature facilitate manufacturing style but it presents an opportunity to use multiple top members 40 with a single lower member 10′.

Thus, purse holders 10, 10¹′, because of their decorative designs, add to the ambiance of a restaurant, private home, or club, and provide a viable alternative to equally unacceptable alternatives of laying a purse on the table or on the floor.

In fact, some restaurants provide stools for female diners to set their purses on, as opposed to placing them on the floor.

The subject invention provides a way to improve a table setting over the stool option by improving the decorative appearance of the table by the use of purse holders 10, 10¹.

It will be appreciated that the present invention may be adapted for utilization beyond the specific environments discussed herein. Accordingly, the present invention is not limited to the specific embodiments described herein, but is defined by the scope and spirit of the following claims.

1. A purse holder for use in conjunction with a table like surface comprising:
a first member including a first portion to receive a handbag and a second portion; and
a second member for receiving said second portion of said first member in slidable fashion, said second portion of said first member having means to prevent the complete disengagement of said first and second members.

2. The purse holder of claim 1 wherein said second member has an opening and said means to prevent the disengagement of said first and second member is a knob on said second portion of said first member.

3. The purse holder of claim 2 wherein the slideablity of said second portion of said first member within said second member enables the adjustability of said purse holder to facilitate its use on different sizes of table like surfaces.

4. The purse holder of claim 2 wherein said knob is selectively removable.

5. A purse holder for resting on a horizontal surface comprising:
a first member on which a purse will be held;
a second member for resting on the horizontal surface, said first member slideably connected to said second member.

6. The purse holder of claim 5 wherein said first member has a hook-like portion to provide a means of engagement with the purse.

7. The purse holder of claim 5 wherein said second member has an opening for receiving a portion of said first member.

8. The purse holder of claim 7 wherein said portion of said first member has a third member attached thereto which is larger than said opening.

9. The purse holder of claim 5 wherein said second member is a purse replica.

10. The purse holder of claim 5 wherein said second member is a shoe replica.

11. The purse holder of claim 5 wherein said second member is a recognizable design replica.

12. The purse holder of claim 6 wherein said hook-like portion is oriented to cause the purse to hang in a desired manner.

13. The purse holder of claim 6 further including means to change the orientation of the purse when hanging.

14. The purse holder of claim 5 further including means to change the orientation of a purse as it hangs.

15. The purse holder of claim 14 wherein said means to change the orientation of a purse as it hangs is a ring.
